(19) United States
(12) Patent Application Publication
(10) Pub. No.: US 2026/0177145 A1
(43) Pub. Date: Jun. 25, 2026

(54) LOCKING DEVICE, PRESSURE CONTAINER AND LOCKING METHOD

(71) Applicant: Tokyo Electron Limited, Tokyo (JP)

(72) Inventors: Cheng Hsiung LEE, Hsinchu City (TW); Chun Hung HUNG, Hsinchu City (TW); Fu Chieh HSU, Hsinchu City (TW); Chi Ming KUO, Hsinchu City (TW); Chun Hung HUNG, Hsinchu City (TW)

(21) Appl. No.: 19/413,498

(22) Filed: Dec. 9, 2025

Related U.S. Application Data
(60) Provisional application No. 63/738,370, filed on Dec. 23, 2024.

(51) Int. Cl. F16J 13/08

(52) U.S. Cl. CPC F16J 13/08

(57) ABSTRACT

A locking device, a pressure container and a locking method are provided. The locking device includes a first element, a second element, a first movable element, a second movable element and a sustaining structure. The first element defines a first recess and a second recess opposite to the first recess. The second element is accommodated in the first element. The first movable element is configured to be inserted into the first recess and contact the second element. The second movable element is configured to be inserted into the second recess and contact the second element. The sustaining structure is disposed between the first movable element and the second movable element, and is configured to prevent the first movable element and the second movable element from moving away from the first recess and the second recess, respectively.

### CROSS-REFERENCE TO RELATED APPLICATIONS

This application claims priority to U.S. Provisional Application No. 63/738,370, filed on Dec. 23, 2024, the entire content of which is incorporated herein by reference.

### TECHNICAL FIELD

The present disclosure relates to a locking device, a pressure container and a locking method, and in particular, to a locking device including a sustaining structure, a pressure container including the same and a locking method corresponding the same.

### BACKGROUND

In a conventional processing method, a workpiece is placed in a pressure container that accommodates a high-pressure gas for processing the workpiece. The pressure container typically includes a lid or a cover to seal its chamber. When the lid is large and the gas is maintained at a correspondingly high pressure, the pressure exerted on the lid can become very high, increasing a risk of failure. Therefore, the conventional technology has developed a rather complicated locking mechanism to ensure the precise positioning of the lid and to prevent potential failure automatically. However, the manufacturing cost of the complicated locking mechanism is excessively high, and its locking effectiveness needs improvement. Consequently, there is a need for a locking device with a simple structure and an excellent locking performance to address the aforementioned issues.

### SUMMARY

In some embodiments, a locking device includes a first element, a second element, a first movable element, a second movable element and a sustaining structure. The first element defines a first recess and a second recess opposite to the first recess. The second element is accommodated in the first element. The first movable element is configured to be inserted into the first recess and contact the second element. The second movable element is configured to be inserted into the second recess and contact the second element. The sustaining structure is disposed between the first movable element and the second movable element, and is configured to prevent the first movable element and the second movable element from moving away from the first recess and the second recess, respectively.

In some embodiments, a pressure container includes a housing, a lid and a locking device. The housing defines a chamber. The lid is configured to cover an opening of the housing. The locking device is configured to secure the lid in the opening of the housing. The locking device includes a plurality of locking elements and a sustaining element. The plurality of locking elements are movable along a first direction. The plurality of locking elements are non-rotatable. The sustaining element is movable along a second direction substantially perpendicular to the first direction. The sustaining element is configured to be disposed between the plurality of locking elements to sustain the plurality of locking elements.

In some embodiments, a locking method includes: providing a second element surround by a first element defining a plurality of recesses; moving a plurality of movable elements into the plurality of recesses respectively, wherein a second portion of one of the plurality of movable elements is located outside one of the plurality of recesses; and moving a sustaining element to a position between the plurality of movable elements, wherein the sustaining element is configured to sustain the plurality of movable elements.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates a cross-sectional view of a pressure container according to some embodiments of the present disclosure, wherein the locking device of the pressure container is illustrated in a front view rather in a cross-sectional view.

FIG. 2 illustrates an enlarged view of an area “A” of FIG. 1.

FIG. 3 illustrates a bottom view of the pressure container of FIG. 1, wherein a supporter is omitted.

FIG. 4 illustrates an enlarged view of an area “B” of FIG. 1.

FIG. 5 illustrates an enlarged view of an area of a pressure container according to some embodiments of the present disclosure.

FIG. 6 illustrates an enlarged view of an area of a pressure container according to some embodiments of the present disclosure.

FIG. 7 illustrates an enlarged view of an area of a pressure container according to some embodiments of the present disclosure.

FIG. 8 illustrates one or more stages of an example of a locking method according to some embodiments of the present disclosure.

FIG. 9 illustrates one or more stages of an example of a locking method according to some embodiments of the present disclosure.

FIG. 10 illustrates one or more stages of an example of a locking method according to some embodiments of the present disclosure.

FIG. 11 illustrates one or more stages of an example of a locking method according to some embodiments of the present disclosure.

FIG. 12 illustrates one or more stages of an example of a locking method according to some embodiments of the present disclosure.

FIG. 13 illustrates a bottom view of a sustaining element according another embodiment of the present disclosure.

FIG. 14 illustrates one or more stages of an example of a locking method according to some embodiments of the present disclosure.

FIG. 15 illustrates one or more stages of an example of a locking method according to some embodiments of the present disclosure.

FIG. 16 illustrates one or more stages of an example of a locking method according to some embodiments of the present disclosure.

### DETAILED DESCRIPTION

The components, values, operations, materials and configurations in the following disclosure are merely embodiments or examples and are not intended to be limiting. For example, a first element being formed over or on a second element may include different implementations. The first element and the second element may be in direct contact. Alternatively, the first element and the second element may not be in direct contact, and an additional element between the first element and the second element may be included.

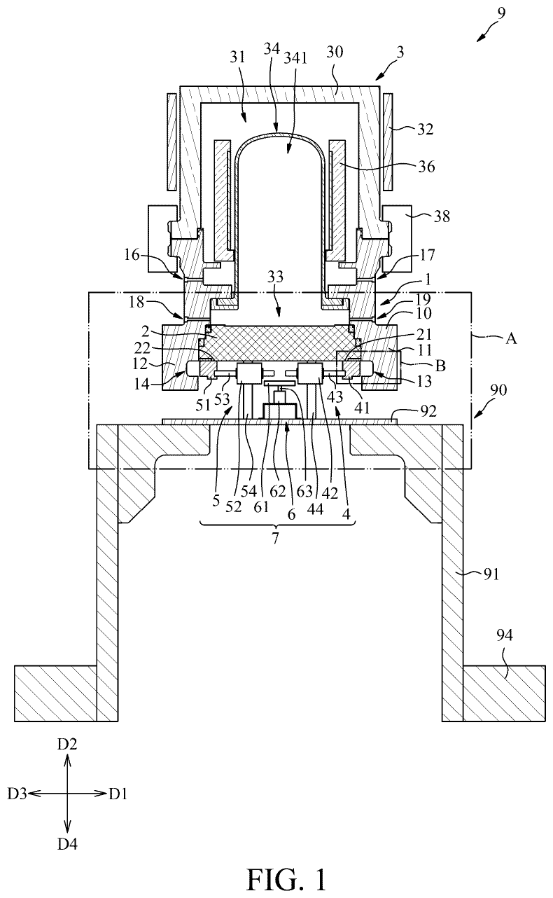

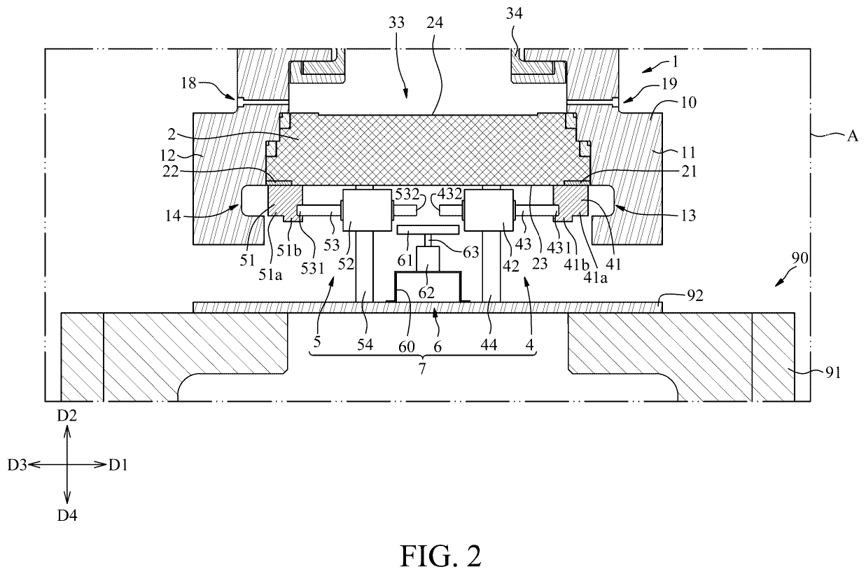

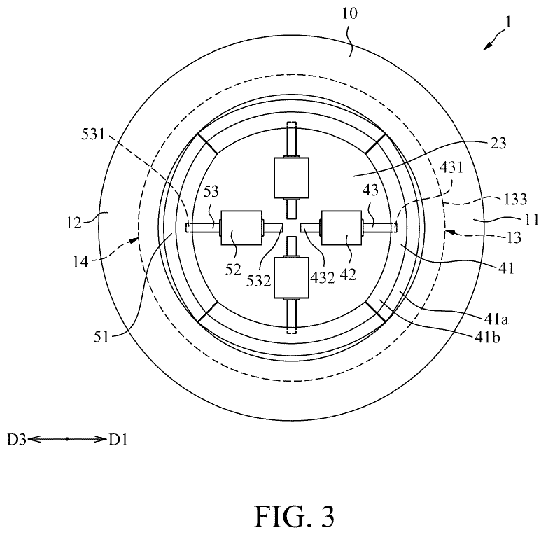

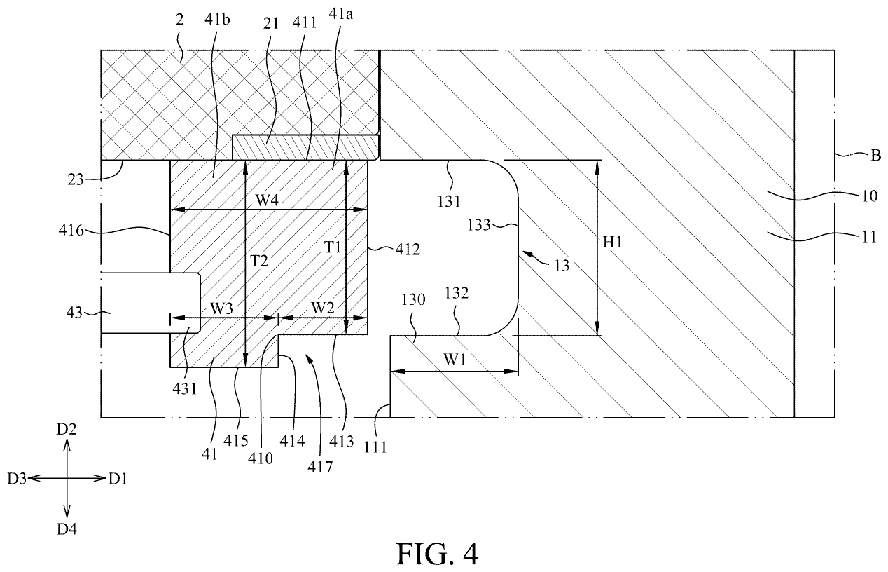

FIG. 1 illustrates a cross-sectional view of a pressure container 9 according to some embodiments of the present disclosure, wherein the locking device 7 of the pressure container 9 is illustrated in a front view rather in a cross-sectional view. FIG. 2 illustrates an enlarged view of an area “A” of FIG. 1. FIG. 3 illustrates a bottom view of the pressure container 9 of FIG. 1, wherein a supporter 90 is omitted. FIG. 4 illustrates an enlarged view of an area “B” of FIG. 1. The pressure container 9 may be a semiconductor equipment with dual chamber or an annealing equipment. The pressure container 9 may be also referred to as “a pressure vessel” or “a high pressure equipment”.

The pressure container 9 may include a supporter 90, a housing 3, a quartz tube 34, a heater 36, a cooler 32, a lid 2 and locking device 7. The supporter 90 may include a lifting mechanism 91, a motor 94 and a receiving plate 92. The lifting mechanism 91 may be a rigid structure. The motor 94 may be connected to the lifting mechanism 91. The receiving plate 92 may be disposed on the top of the lifting mechanism 91. During operation, the motor 94 may drive the receiving plate 92 to move upward along a second direction D2 and to move downward along a fourth direction D4 through the lifting mechanism. Both of the fourth direction D4 and the second direction D2 are vertical directions. The fourth direction D4 may be opposite to the second direction D2.

The housing 3 may include a metal material such as stainless steel. The housing 3 may define a chamber 31 (or a cavity or an accommodating space). The chamber 31 may be also referred to as “an outer chamber”. The housing 3 may be also referred to as “a pressure vessel”. The housing 3 may include a base portion 1 and an upper portion 30 detachably attached to the base portion 1 through a clamping device 38. The base portion 1 and the upper portion 30 may collectively define the chamber 31 (or the cavity or the accommodating space). The base portion 1 may be also referred to as “a lower portion”. The lower portion (i.e., the base portion 1) of the housing 3 may define an opening 33.

The quartz tube 34 and the heater 36 may be disposed in the chamber 31. The quartz tube 34 may define an inner chamber 341 (or an inner cavity or an inner accommodating space) in communication with the opening 33 of the housing 3 (or an opening of the base portion 1). The quartz tube 34 may be also referred to as “a pressure vessel”. The heater 36 may be disposed around the quartz tube 34 to heat the quartz tube 34 to make the temperature in the inner chamber 341 reach the process temperature. The heater 36 may surround an upper end of the quartz tube 34. The cooler 32 may be disposed around the housing 3 to adjust or control the temperature in the inner chamber 341 and the temperature in the chamber 31 (or the cavity or the accommodating space). The cooler 32 may be disposed outside the chamber 31, and may surround an upper end of the housing 3.

In one embodiment, the base portion 1 may be also referred to as “a first element”, and the lid 2 may be may be also referred to as “a second element”.

The base portion 1 (e.g., the first element) may include a metal material such as stainless steel. The base portion 1 (e.g., the first element) may include a ring structure, and may include a sidewall 10. The base portion 1 may define a first gas intake channel 16, a first gas exhaust channel 17, a second gas intake channel 18 and a second gas exhaust channel 19. The first gas intake channel 16 and the first gas exhaust channel 17 may extend through the sidewall 10 of the base portion 1 so as to communicate the chamber 31 and the external space outside the housing 3. Thus, a first gas (e.g., an inert gas) may enter the chamber 31 through the first gas intake channel 16, and may leave the chamber 31 through the first gas exhaust channel 17. In addition, the second gas intake channel 18 and the second gas exhaust channel 19 may extend through the sidewall 10 of the base portion 1 so as to communicate the inner chamber 341 and the external space outside the housing 3. Thus, a second gas (e.g., a process gas) may enter the inner chamber 341 through the second gas intake channel 18, and may leave the inner chamber 341 through the second gas exhaust channel 19.

As shown in the cross-sectional view of FIG. 1, the sidewall 10 of the base portion 1 may include a first portion 11 and a second portion 12 opposite to the first portion 11. The first portion 11 of the sidewall 10 may have an inner surface 111 (FIG. 4). The first portion 11 of the sidewall 10 may define a first recess 13 (or a first opening or a first groove or a first accommodating space) recessed from the inner surface 111 of the first portion 11 of the sidewall 10. The second portion 12 of the sidewall 10 may define a second recess 14 (or a second opening or a second groove or a second accommodating space) recessed from an inner surface of the sidewall 10. The second recess 14 may be opposite to the first recess 13. Alternatively, the second recess 14 and the first recess 13 face each other. The first recess 13 and the second recess 14 may be curved from a bottom view as shown in FIG. 3. As shown in FIG. 4, the first recess 13 may have a top inner surface 131, a bottom inner surface 132 opposite to the top inner surface 131 and a lateral inner surface 133 extending between the top inner surface 131 and the bottom inner surface 132. The first recess 13 may have a width W1 and a height H1. In some embodiments, the first recess 13 and the second recess 14 may be portions of a same groove. Thus, a size of the second recess 14 may be same as a size of the first recess 13. The second recess 14 may have a top inner surface, a bottom inner surface opposite to the top inner surface and a lateral inner surface extending between the top inner surface and the bottom inner surface. The second recess 14 may have a width W1 and a height H1.

As shown in FIG. 1 and FIG. 2, the lid 2 (e.g., the second element) may include a metal material such as stainless steel. The lid 2 (e.g., the second element) may be also referred to as “a cover” or “a cap”. The lid 2 (e.g., the second element) may be accommodated in the base portion 1 (e.g., the first element), and may be configured to be disposed between the first recess 13 and the second recess 14. For example, the lid 2 (e.g., the second element) may be disposed between the second recess 14 and the second gas intake channel 18. In addition, the lid 2 (e.g., the second element) may be disposed between the first recess 13 and the second gas exhaust channel 19. The lid 2 may be disposed under the inner chamber 341, and under the quartz tube 34. The lid 2 may be configured to cover the opening 33 of the housing 3 (or the opening of the base portion 1). A width of the lid 2 may be substantially equal to a width of the opening 33 of the housing 3 (or the opening of the base portion 1). A profile of the lateral surface of the lid 2 may be substantially conformal with a profile of the opening 33 of the housing 3 (or the opening of the base portion 1). For example, the lid 2 may include a step structure which corresponds to the step profile of the opening 33 of the housing 3 (or the opening of the base portion 1) in a cross-sectional view. The lid 2 (e.g., the second element) may have a top surface 24 and a bottom surface 23 opposite to the top surface 24.

The locking device 7 may be disposed under the lid 2. The locking device 7 may be attached to the receiving plate 92, and may be configured to secure the lid 2 in the opening 33 of the housing 3. The locking device 7 may include a plurality of locking assembles and a sustaining structure 6. The plurality of locking assembles may include a first locking assembly 4 and a second locking assembly 5. The first locking assembly 4 may include a first movable element 41 (or a first fastener or a first block), a first driving component 42, a first bar 43 and a first support structure 44. The first support structure 44 may be a bar structure or a pillar structure. A top end of the first support structure 44 may contact or connect to a bottom surface 23 of the lid 2. A bottom end of the first support structure 44 may be attached to the receiving plate 92. The first driving component 42 may be attached to the first support structure 44 and may be configured to drive the first movable element 41. The first driving component 42 may be a biaxial power component. The first bar 43 may extend through the first driving component 42. The first bar 43 may be driven by the first driving component 42.

A first end 431 of the first bar 43 may connect to the first movable element 41. The first end 431 of the first bar 43 may be fixed to the first movable element 41. For example, the first end 431 of the first bar 43 may be disposed in the first movable element 41. The first end 431 of the first bar 43 may be screwed into a screw hole of the first movable element 41. A second end 432 of the first bar 43 may be configured to contact a sustaining element 61 of the sustaining structure 6. The first bar 43 may be a single bar, and the first end 431 may be aligned with the second end 432. A central axis of the first end 431 may be the same as a central axis of the second end 432. The first end 431 and the second end 432 are disposed at two opposite sides of the first driving component 42. The first end 431 and the second end 432 may move simultaneously when the first bar 43 is driven by the first driving component 42.

The first movable element 41 (or the first fastener or the first block) may include a metal material such as stainless steel. The first movable element 41 may be configured to be inserted into the first recess 13, and may contact or support the bottom surface 23 of the lid 2 (e.g., the second element). The first movable element 41 may slide on the bottom surface 23 of the lid 2 (e.g., the second element). The first movable element 41 may be a curved plate from the bottom view (FIG. 3). A curvature of the first movable element 41 may be same as or different from a curvature of the first recess 13.

The second locking assembly 5 may include a second movable element 51 (or a second fastener or a second block), a second bar 53, a second driving component 52 and a second support structure 54. The second support structure 54 may be a bar structure or a pillar structure. A top end of the second support structure 54 may contact or connect to the bottom surface 23 of the lid 2. A bottom end of the second support structure 54 may be attached to the receiving plate 92. The second driving component 52 may be attached to the second support structure 54 and may be configured to drive the second movable element 51. The second driving component 52 may be a biaxial power component. The second driving component 52 may include a second bar 53. The second bar 53 may extend through the second driving component 52. The second bar 53 may be driven by the second driving component 52.

A first end 531 of the second bar 53 may connect to the second movable element 51. The first end 531 of the second bar 53 may be fixed to the second movable element 51. For example, the first end 531 of the second bar 53 may be disposed in the second movable element 51. The first end 531 of the second bar 53 may be screwed into a screw hole of the second movable element 51. A second end 532 of the second bar 53 may be configured to contact the sustaining structure 6. The second bar 53 may be a single bar, and the first end 531 may be aligned with the second end 532. A central axis of the first end 531 may be the same as a central axis of the second end 532. The first end 531 and the second end 532 are disposed at two opposite sides of the second driving component 52. The first end 531 and the second end 532 may move simultaneously when the second bar 53 is driven by the second driving component 52. In some embodiments, a central axis of the second bar 53 and a central axis of the first bar 43 may be the same axis.

The second movable element 51 (or the second fastener or the second block) may include a metal material such as stainless steel. The second movable element 51 may be configured to be inserted into the second recess 14, and may contact or support the bottom surface 23 of the lid 2 (e.g., the second element). The second movable element 51 may slide on the bottom surface 23 of the lid 2 (e.g., the second element). The second movable element 51 may be a curved plate from the bottom view (FIG. 3). A curvature of the second movable element 51 may be same as or different from a curvature of the second recess 14.

As shown in FIG. 3, the first recess 13 may be communicated with the second recess 14. The first movable element 41 may be separated from the second movable element 51. As shown in FIG. 4, the bottom surface 23 of the lid 2 (e.g., the second element) may be substantially aligned with the top inner surface 131 of the first recess 13. Similarly, the bottom surface 23 of the lid 2 (e.g., the second element) may be substantially aligned with the top inner surface of the second recess 14.

As shown in FIG. 4, the first movable element 41 may have a first surface 411 (e.g., a top surface), a second surface 412, a third surface 413 (e.g., an outer bottom surface), a fourth surface 414 (e.g., an intermediate lateral surface), a fifth surface 415 (e.g., an inner bottom surface) and a sixth surface 416. The first surface 411 may face the bottom surface 23 of the lid 2 (e.g., the second element). The second surface 412 and the fourth surface 414 may face the first recess 13. The third surface 413 and the fifth surface 415 may be opposite to the first surface 411. The sixth surface 416 may be opposite to the second surface 412. The first movable element 41 may include a first portion 41a (e.g., an outer portion) and a second portion 41b (e.g., an inner portion) opposite to the first portion 41a. The first portion 41a may be defined by a portion of the first surface 411, the second surface 412 and the third surface 413. The second portion 41b may be defined by a portion of the first surface 411, the fourth surface 414, the fifth surface 415 and the sixth surface 416. The first portion 41a and the second portion 41b may be formed integrally as a monolithic structure.

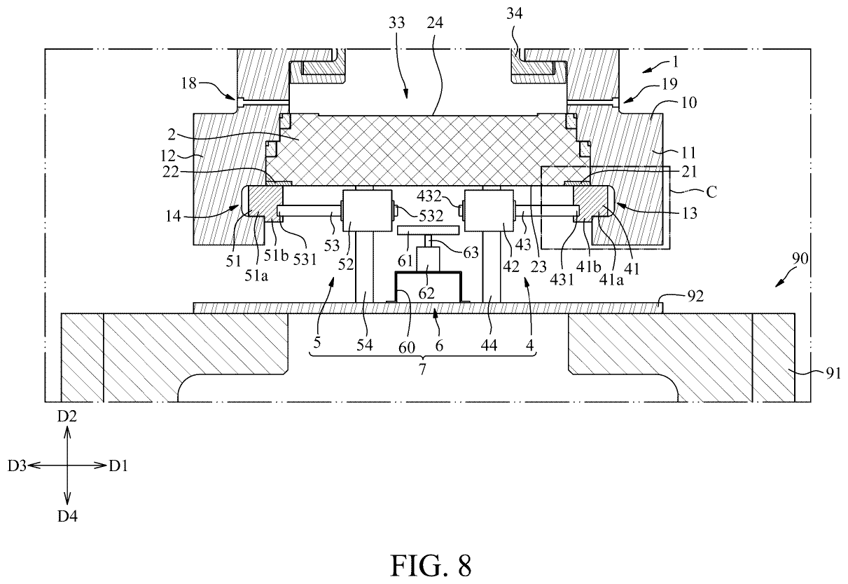

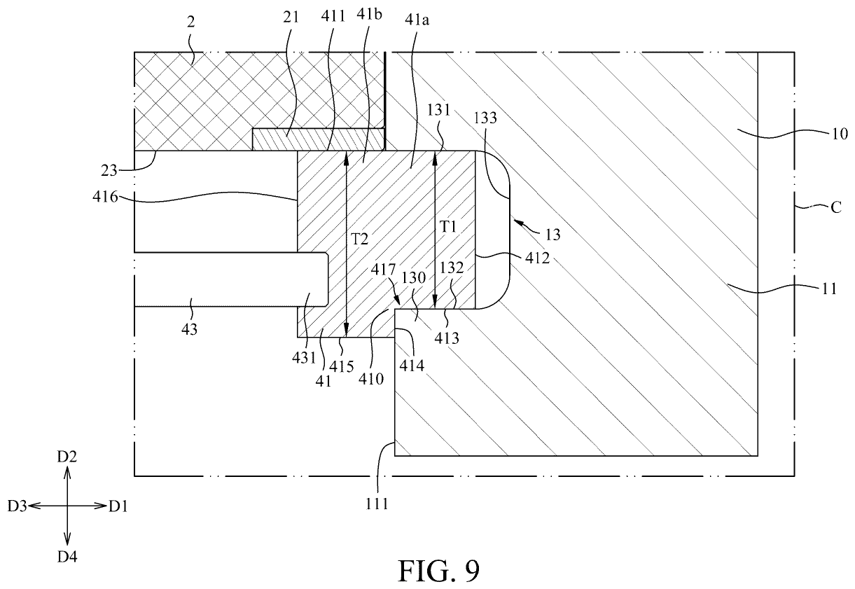

As shown in FIG. 4, the first movable element 41 may define an indentation 417 (or a corner notch or a recess corner) at its corner 410. Thus, the first movable element 41 may be a step structure. A width W2 of the indentation 417 may be less than the width W1 of the first recess 13. The indentation 417 (or the corner notch or the recess corner) may be defined by the third surface 413 and the fourth surface 414. The third surface 413 and the fourth surface 414 may be configured to contact two surfaces (i.e., the bottom inner surface 132 and the inner surface 111) of a corner 130 of the first recess 13 or a corner 130 of the first portion 11 of the sidewall 10 of the base portion 1, respectively, as shown in FIG. 8 and FIG. 9.

As shown in FIG. 4, the first portion 41a of the first movable element 41 may have a first thickness T1 and a first width W2. The second portion 41b of the first movable element 41 may have a second thickness T2 and a second width W3. The second thickness T2 may be different from the first thickness T1. The first thickness T1 may be substantially equal to the height H1 of the first recess 13. The second thickness T2 may be greater than the height H1 of the first recess 13. The second thickness T2 may be greater than the first thickness T1. The first movable element 41 may have a maximum thickness T2 and a maximum width W4. The maximum width W4 of the first movable element 41 may be greater than the width W1 of the first recess 13. It is noted that the structure and size of the second movable element 51 may be the same as the structure and size of the first movable element 41. As shown in FIG. 2, the second movable element 51 may include a first portion 51a (e.g., an outer portion) and a second portion 51b (e.g., an inner portion) opposite to the first portion 51a. The second movable element 51 may define an indentation (or a corner notch or a recess corner) at its corner.

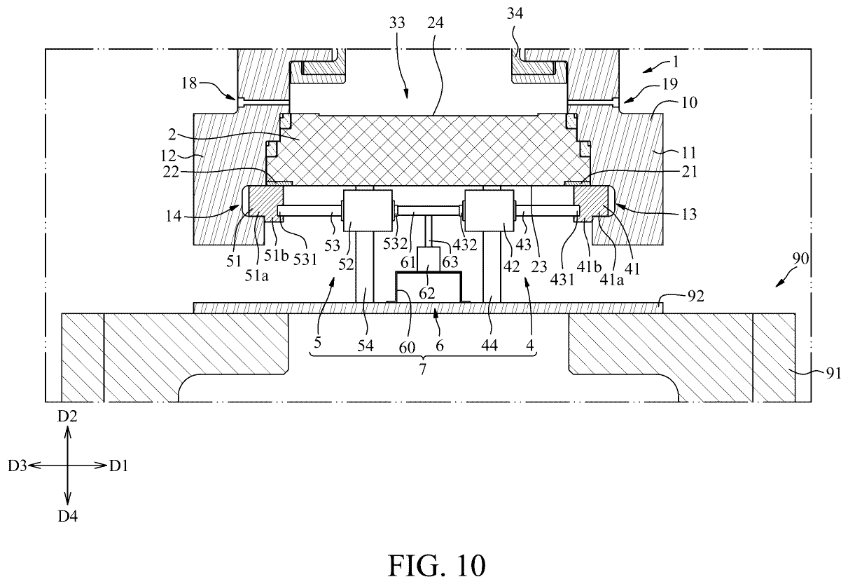

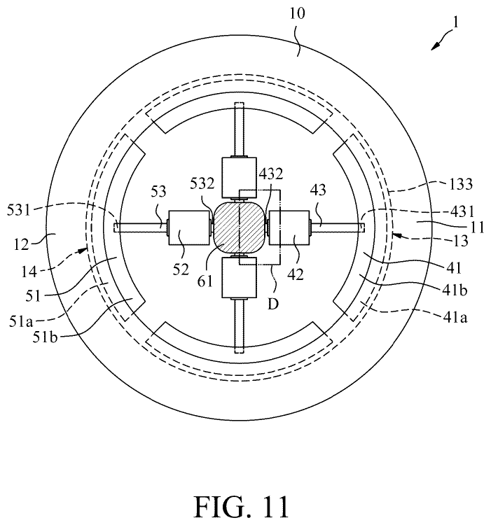

As shown in FIG. 1 and FIG. 2, the sustaining structure 6 may include a support structure 60, a driving component 62 and a sustaining element 61. The support structure 60 may be attached to or fixed on the receiving plate 92, and may be configured to support the driving component 62. The driving component 62 may be disposed on the support structure 60. The driving component 62 may include a connecting bar 63 connecting and supporting the sustaining element 61. Thus, the driving component 62 may be configured to drive the sustaining element 61 to move upward along the second direction D2 or to move downward along the fourth direction D4. In some embodiments, the sustaining structure 6 may be disposed between the first movable element 41 and the second movable element 51, and may be configured to prevent the first movable element 41 and the second movable element 51 from moving away from the first recess 13 and the second recess 14, respectively, as shown in FIG. 10 and FIG. 11.

As shown in FIG. 10 and FIG. 11, the sustaining element 61 may be configured to sustain the first movable element 41 through the first bar 43, and sustain the second movable element 51 through the second bar 53. The sustaining element 61 may be a square plate from a bottom view.

As shown in FIG. 1 and FIG. 2, the first movable element 41 may be a first locking element that is movable along a first direction D1 (e.g., a horizontal direction). The second movable element 51 may be a second locking element that is movable along a third direction D3 (i.e., the horizontal direction) opposite to the first direction D1. The first movable element 41 and the second movable element 51 are non-rotatable. That is, the first movable element 41 and the second movable element 51 do not rotate during the moving stage. The sustaining element 61 may be movable along the second direction D2 (e.g., a vertical direction) substantially perpendicular to the first direction D1. The sustaining element 61 is configured to be disposed between a plurality of locking elements (including the first movable element 41 and the second movable element 51) to sustain the plurality of locking elements. The sustaining element 61 is configured to sustain the plurality of locking elements (including the first movable element 41 and the second movable element 51) by face-to-face contact. A resistance force between one of the plurality of locking elements (including the first movable element 41 or the second movable element 51) and the sustaining element 61 is along the first direction D1 or the third direction D3 or a direction on a plane including the first direction D1 and the third direction D3.

In some embodiments, a first wear-resisting component 21 and a second wear-resisting component 22 may be embedded in the lid 2 (e.g., the second element). The first wear-resisting component 21 and the second wear-resisting component 22 may be exposed from the bottom surface 23 of the lid 2 (e.g., the second element). A bottom surface of the first wear-resisting component 21 and a bottom surface of the second wear-resisting component 22 may be substantially coplanar with the bottom surface 23 of the lid 2 (e.g., the second element). The first movable element 41 and the second movable element 51 may be configured to slide on the first wear-resisting component 21 and the second wear-resisting component 22, respectively. The first wear-resisting component 21 and the second wear-resisting component 22 may include a metal material such as stainless steel. A hardness of the first movable element 41 and the second movable element 51 may be greater than a hardness of the first wear-resisting component 21 and the second wear-resisting component 22. The first wear-resisting component 21 and the second wear-resisting component 22 are replaceable.

As shown in FIG. 1 and FIG. 2, the locking device 7 include less component as compared with prior art. Thus, the manufacturing cost of the locking device 7 may be reduced. As shown in FIG. 8, FIG. 9 and FIG. 10, when the third surface 413 and the fourth surface 414 of the first movable element 41 contact the bottom inner surface 132 and the inner surface 111 of the corner 130 of the first recess 13, respectively, the stresses occur at the corner 410 of the first movable element 41 and the corner 130 of the first recess 13 are reduced efficiently due to the design of the indentation 417 (or the corner notch or the recess corner). Thus, the life of the first movable element 41 and the base portion 1 may be improved. Further, the second driving component 52, the first driving component 42, the driving component 62 and the motor 94 may be electrically connected to a control unit, so that the locking method of the locking device 7 may be performed automatically. In addition, the locking device 7 may ensure the precise positioning of the lid 2 (e.g., the second element), and may prevent potential failure.

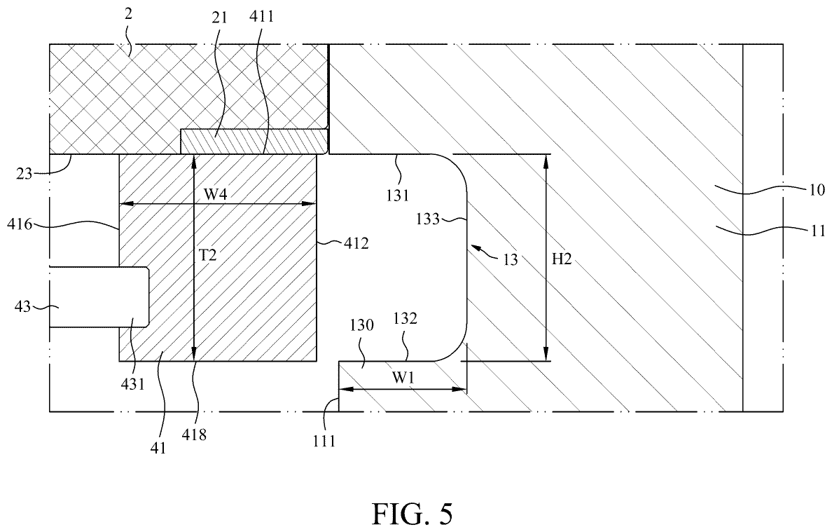

FIG. 5 illustrates an enlarged view of an area of a pressure container according to some embodiments of the present disclosure. The pressure container of FIG. 5 is similar to the pressure container 9 of FIG. 1 and FIG. 4, except that the first movable element 41 may have a consistent thickness T2 that is substantially equal to the height H2 of the first recess 13. The first movable element 41 may be a complete square in the cross section. The first movable element 41 may have an eighth surface 418 opposite to the first surface 411. A width of the eighth surface 418 is substantially equal to a width of the first surface 411.

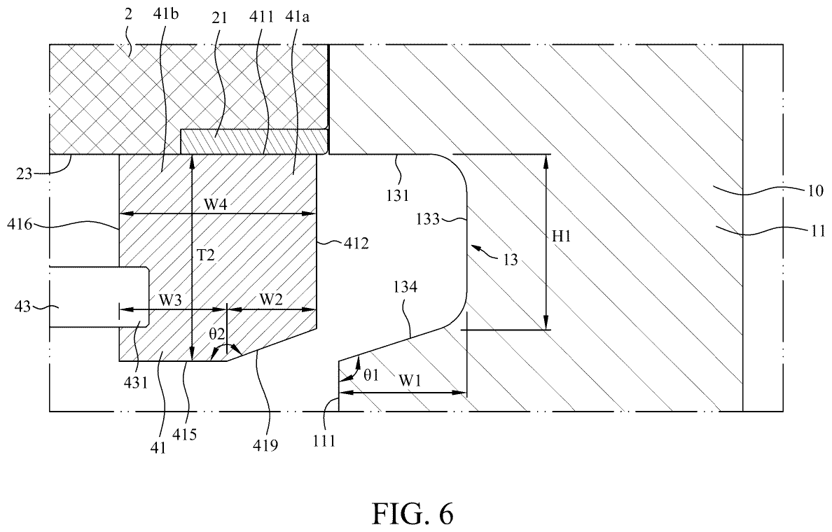

FIG. 6 illustrates an enlarged view of an area of a pressure container according to some embodiments of the present disclosure. The pressure container of FIG. 6 is similar to the pressure container 9 of FIG. 1 and FIG. 4, except that the first movable element 41 may have a ninth surface 419 extending between the second surface 412 and the fifth surface 415. The slanted ninth surface 419 may connect the second surface 412 and the fifth surface 415 of the first movable element 41. The slanted ninth surface 419 may be configured to contact the slanted bottom inner surface 134 of the first recess 13. In addition, an angle θ1 between the bottom inner surface 134 of the first recess 13 and the inner surface 111 of the first portion 11 of the sidewall 10 may be greater than 90 degrees, such as 95 degrees, 100 degrees, 105 degrees, 110 degrees, 120 degrees, 130 degrees, or 135 degrees. An angle θ2 between the slanted ninth surface 419 and the fifth surface 415 may be greater than 90 degrees and less than 180 degrees, such as 175 degrees, 170 degrees, 165 degrees, 160 degrees, 150 degrees, 140 degrees or 135 degrees. A sum of the angle θ1 and the angle θ2 may be substantially equal to 270 degrees. The first movable element 41 may taper toward the first recess 13. The first recess 13 may taper away from the first movable element 41.

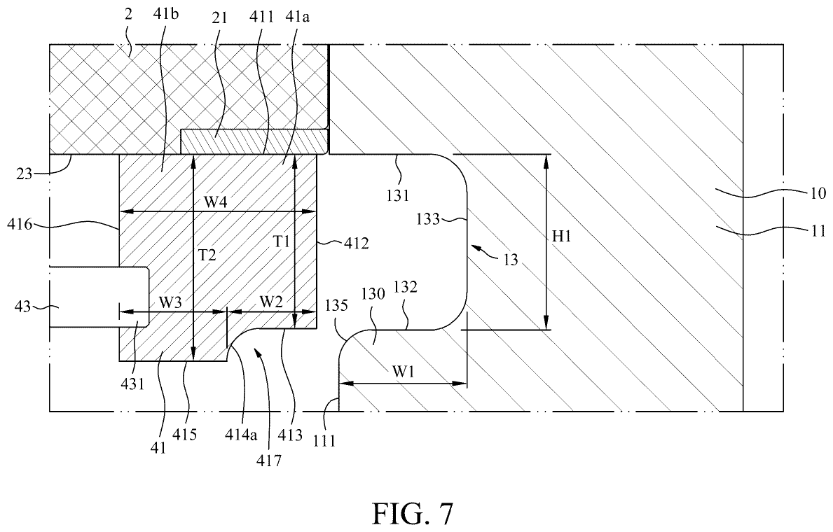

FIG. 7 illustrates an enlarged view of an area of a pressure container according to some embodiments of the present disclosure. The pressure container of FIG. 7 is similar to the pressure container 9 of FIG. 1 and FIG. 4, except that the fourth surface 414a of the first movable element 41 may be a curved surface, and the corner 130 of the first recess 13 may have a curved surface 135. A curvature and a size of the fourth surface 414a of the first movable element 41 may be substantially equal to a curvature and a size of the curved surface 135 of the corner 130 of the first recess 13.

FIG. 1 to FIG. 4, FIG. 8 to FIG. 15 illustrates a locking method according to some embodiments of the present disclosure. The locking method may be accomplished by the pressure container 9 illustrated in FIG. 1 to FIG. 4.

Referring to FIG. 1 to FIG. 4, the pressure container 9 may be provided. The pressure container 9 may include a supporter 90, a housing 3, a quartz tube 34, a heater 36, a cooler 32, a lid 2 (e.g., a second element) and locking device 7. The supporter 90 may include a lifting mechanism 91, a motor 94 and a receiving plate 92. The housing 3 may include a base portion 1 (e.g., a first element) and an upper portion 30 detachably attached to the base portion 1 through a clamping device 38. The base portion 1 and the upper portion 30 may collectively define the chamber 31 (or the cavity or the accommodating space). The base portion 1 of the housing 3 may define an opening 33. The lid 2 (e.g., the second element) may be surrounded by the base portion 1 (e.g., the first element). The base portion 1 (e.g., the first element) may define a plurality of recesses (e.g., a first recess 13 and a second recess 14).

The locking device 7 may be disposed under the lid 2. The locking device 7 may include a plurality of locking assembles and a sustaining structure 6. The plurality of locking assembles may include a first locking assembly 4 and a second locking assembly 5. The first locking assembly 4 may include a first movable element 41 (or a first fastener or a first block), a first bar 43, a first driving component 42 and a first support structure 44. The second locking assembly 5 may include a second movable element 51 (or a second fastener or a second block), a second bar 53, a second driving component 52 and a second support structure 54. The sustaining structure 6 may include a support structure 60, a driving component 62 and a sustaining element 61.

Referring to FIG. 8 and FIG. 9, wherein FIG. 9 illustrates an enlarged view of an area “C” of FIG. 8, a plurality of movable elements (e.g., the first movable element 41 and the second movable element 51) may be moved into the recesses (e.g., the first recess 13 and the second recess 14), respectively. Thus, a locking state is formed. For example, the first movable element 41 may be moved along the first direction D1 (e.g., a horizontal direction) to be inserted into the first recess 13 when the first bar 43 is driven by the first driving component 42. The first movable element 41 may move along the first direction D1 straightly without rotation. Specifically, when the first driving component 42 drives the first bar 43 to move along the axial direction (e.g., the first direction D1) of the first bar 43, the first bar 43 will push the first movable element 41 to move along the first direction D1. The first surface 411 of the first movable element 41 may slide on the bottom surface 23 of the lid 2 (e.g., the second element), the bottom surface of the first wear-resisting component 21 and the top inner surface 131 of the first recess 13. After the first movable element 41 enters the first recess 13, the third surface 413 of the first movable element 41 may slide on the bottom inner surface 132 of the first recess 13 until the fourth surface 414 of the first movable element 41 contacts the inner surface 111 of the first portion 11 of the sidewall 10.

The indentation 417 (or the corner notch or the recess corner) of the first movable element 41 defined by the third surface 413 and the fourth surface 414 of the first movable element 41 may substantially fit the corner 130 of the first recess 13 or the corner 130 of the first portion 11 of the sidewall 10 of the base portion 1. The indentation 417 may be substantially conformal with the corner 130. Thus, the third surface 413 of the first movable element 41 may be configured to contact the bottom inner surface 132 of the corner 130 of the first recess 13. The fourth surface 414 of the first movable element 41 may be configured to contact the inner surface 111 of the first portion 11 of the sidewall 10.

The second portion 41b of the first movable element 41 may be located outside the first recess 13, and may support the lid 2 (e.g., the second element). The first portion 41a of the first movable element 41 may be located in the first recess 13. A thickness T1 of the first portion 41a of the first movable element 41 is less than a thickness T2 of the second portion 41b of the first movable element 41.

As shown in FIG. 8, meanwhile, the second movable element 51 and the first movable element 41 may be moved simultaneously. For example, the second movable element 51 may be moved along the third direction D3 (e.g., a horizontal direction) opposite to the first direction D1 to be inserted into the second recess 14 when the second bar 53 is driven by the second driving component 52. The second movable element 51 may move along the third direction D3 straightly without rotation. Specifically, when the second driving component 52 drives the second bar 53 to move along the axial direction (e.g., the third direction D3) of the second bar 53, the second bar 53 will push the second movable element 51 to move along the third direction D3.

A top surface of the second movable element 51 may slide on the bottom surface 23 of the lid 2 (e.g., the second element), the bottom surface of the second wear-resisting component 22 and a top inner surface of the second recess 14. After the second movable element 51 enters the second recess 14, an outer bottom surface of the second movable element 51 may slide on a bottom inner surface of the second recess 14 until an intermediate lateral surface of the second movable element 51 contacts an inner surface of the second portion 12 of the sidewall 10.

An indentation (or the corner notch or the recess corner) of the second movable element 51 defined by the outer bottom surface and the intermediate lateral surface of the second movable element 51 may substantially fit a corner of the second recess 14 or a corner of the second portion 12 of the sidewall 10 of the base portion 1. The indentation may be substantially conformal with the corner. Thus, a second portion 51b of the second movable element 51 may be located outside the second recess 14, and may support the lid 2 (e.g., the second element). A first portion 51a of the second movable element 51 may be located in the second recess 14. A thickness of the first portion 51a of the second movable element 51 is less than a thickness of the second portion 51b of the second movable element 51.

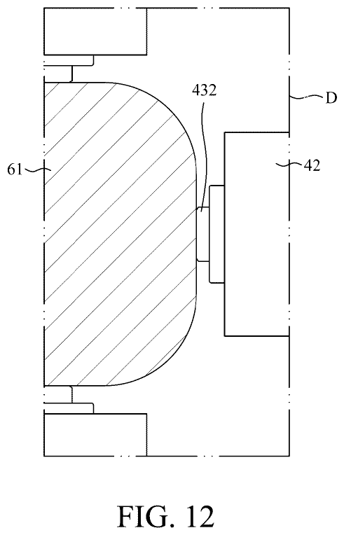

Referring to FIG. 10 to FIG. 12, wherein FIG. 11 illustrates a bottom view of the pressure container 9 of FIG. 10, wherein the supporter 90 is omitted, FIG. 12 illustrates an enlarged view of an area “D” of FIG. 11, the sustaining element 61 of the sustaining structure 6 may be moved to a position between the movable elements (e.g., the first movable element 41 and the second movable element 51). The sustaining element 61 of the sustaining structure 6 may be configured to sustain the movable elements (e.g., the first movable element 41 and the second movable element 51). For example, the sustaining element 61 of the sustaining structure 6 may be moved upward along the second direction D2 by the driving component 62. The second direction D2 may be substantially perpendicular to the first direction D1. Due to the sustaining effect of the sustaining element 61 of the sustaining structure 6, the movable elements (e.g., a first movable element 41 and a second movable element 51) may be secured in the recesses (e.g., the first recess 13 and the second recess 14), respectively.

Referring to FIG. 11 and FIG. 12, the second end 432 of the first bar 43 may contact a lateral surface of the sustaining element 61, and the second end 532 of the second bar 53 may contact the lateral surface of the sustaining element 61. The sustaining element 61 may be interposed or sandwiched between the second end 432 of the first bar 43 and the second end 532 of the second bar 53. Thus, the sustaining element 61 may be configured to sustain the first movable element 41 through the first bar 43, and may sustain the second movable element 51 through the second bar 53. The sustaining structure 6 may be configured to prevent the first movable element 41 and the second movable element 51 from moving away from the first recess 13 and the second recess 14, respectively. As a result, the locking state is enhanced and secured. Then, a processing method may be performed on a workpiece in the chamber 31 of the housing 3 or in the inner chamber 341 of the quartz tube 34.

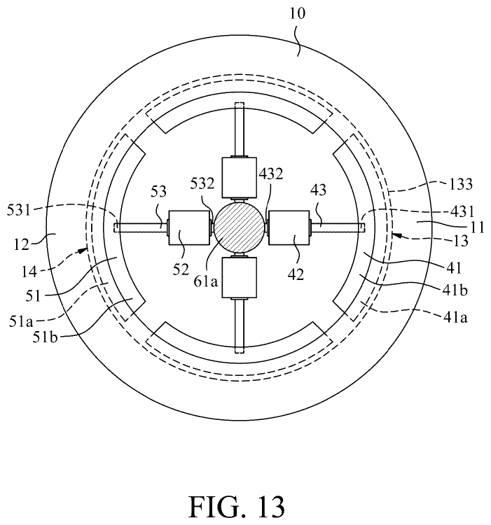

Referring to FIG. 13, a bottom view of a sustaining element 61a according another embodiment is illustrated. The sustaining element 61a may be a circular plate from the bottom view.

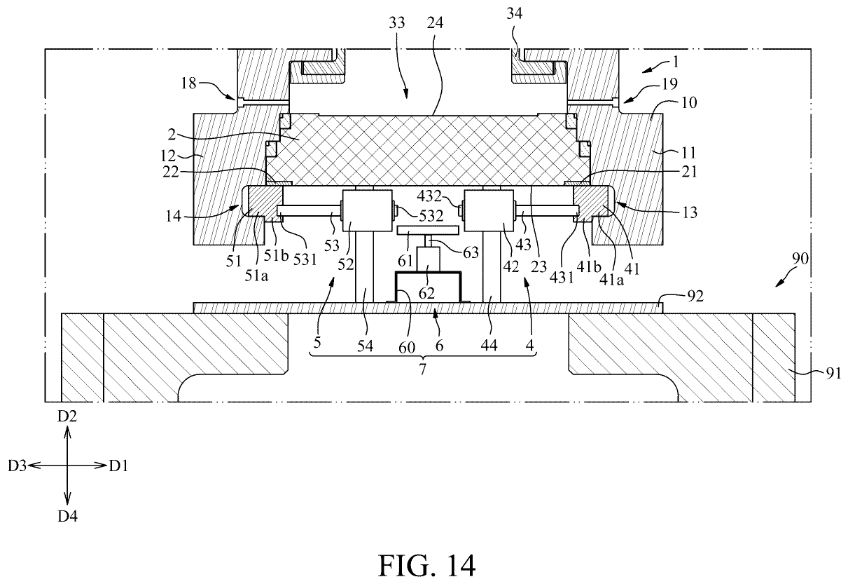

Referring to FIG. 14 to FIG. 16, after the processing method is completed, the housing 3 may be opened as follows. Referring to FIG. 14, the sustaining element 61 of the sustaining structure 6 may be moved downward along the fourth direction D4 by the driving component 62. The fourth direction D4 may be opposite to the second direction D2. Meanwhile, both of the second end 432 of the first bar 43 and the second end 532 of the second bar 53 do not contact the sustaining element 61.

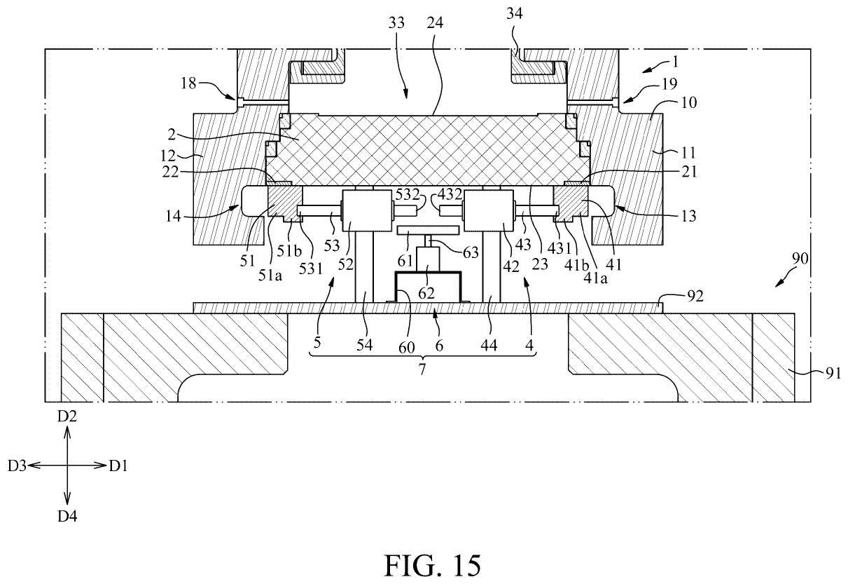

Referring to FIG. 15, the movable elements (e.g., a first movable element 41 and a second movable element 51) may be moved away from the recesses (e.g., the first recess 13 and the second recess 14), respectively. For example, the first movable element 41 may be moved along the third direction D3 to leave the first recess 13 by the first driving component 42. Meanwhile, the second movable element 51 may be moved along the first direction D1 to leave the second recess 14 by the second driving component 52. The movable elements (e.g., the first movable element 41 and the second movable element 51) may be moved straightly without rotation. The locking state is released.

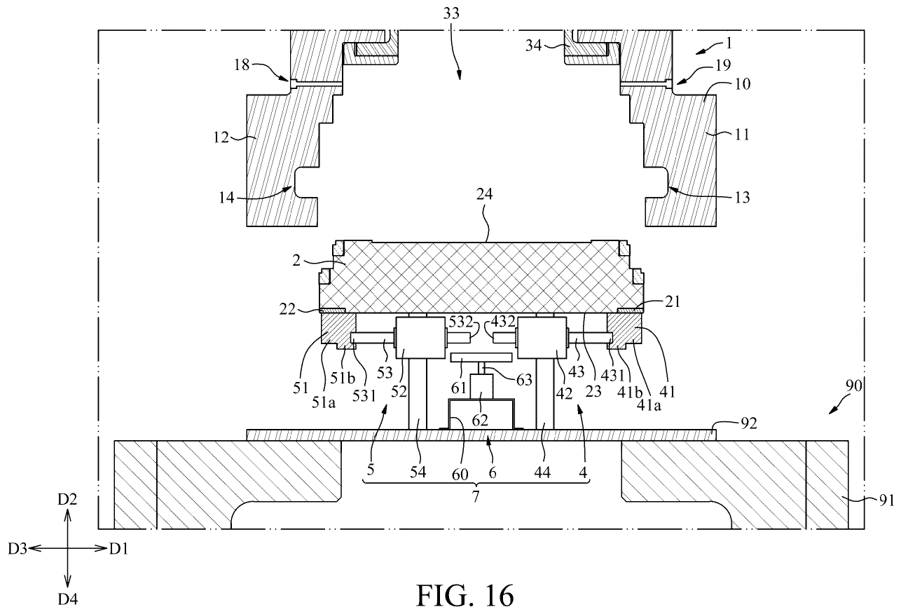

Referring to FIG. 16, the lid 2 (e.g., the second element) and the locking device 7 that are disposed on the supporter 90 may be moved downward together along the fourth direction D4 by the lifting mechanism 91 and the motor 94. Thus, the opening 33 of the housing 3 may be uncovered.

The embodiments disclosed above have the following aspects, for example.

(Clause 1) A locking device, including a first element defining a first recess and a second recess opposite to the first recess; a second element accommodated in the first element; a first movable element configured to be inserted into the first recess and contact the second element; a second movable element configured to be inserted into the second recess and contact the second element; and a sustaining structure disposed between the first movable element and the second movable element, and configured to prevent the first movable element and the second movable element from moving away from the first recess and the second recess, respectively.

(Clause 2) The locking device of Clause 1, wherein the first element includes a ring structure including a sidewall, wherein a first portion of the sidewall defines the first recess, and a second portion of the sidewall defines the second recess, wherein the first recess and the second recess are curved from a bottom view.

(Clause 3) The locking device of Clause 2, wherein the first movable element and the second movable element are curved from the bottom view.

(Clause 4) The locking device of Clause 3, wherein a curvature of the first movable element is same as or different from a curvature of the first recess, wherein a curvature of the second movable element is same as or different from a curvature of the second recess.

(Clause 5) The locking device of Clause 1, wherein the first recess is communicated with the second recess, and the first movable element is separated from the second movable element.

(Clause 6) The locking device of claim 1, wherein a bottom surface of the second element is substantially aligned with a top inner surface of the first recess and a top inner surface of the second recess.

(Clause 7) The locking device of claim 1, wherein the first movable element and the second movable element are configured to slide on a bottom surface of the second element.

(Clause 8) The locking device of Clause 1, wherein the first movable element defines an indentation at a corner thereof, wherein a width of the indentation is less than a width of the first recess.

(Clause 9) The locking device of Clause 1, wherein the first movable element has two surfaces defining a recess corner, wherein the two surfaces of the first movable element are configured to contact two surfaces of a corner of the first recess, respectively.

(Clause 10) The locking device of Clause 1, wherein a first portion of the first movable element has a first thickness, a second portion of the first movable element has a second thickness different from the first thickness.

(Clause 11) The locking device of Clause 1, further including: a first driving component configured to drive the first movable element; and a second driving component configured to drive the second movable element.

(Clause 12) The locking device of Clause 11, wherein the first driving component includes a first bar, a first end of the first bar connects to the first movable element, and a second end of the first bar is configured to contact the sustaining structure; wherein the second driving component includes a second bar, a first end of the second bar connects to the second movable element, and a second end of the second bar is configured to contact the sustaining structure.

(Clause 13) The locking device of Clause 12, wherein the first end of the first bar is fixed to the first movable element, and the first end of the second bar is fixed to the second movable element.

(Clause 14) The locking device of Clause 1, wherein the sustaining structure includes a sustaining element configured to sustain the first movable element and the second movable element.

(Clause 15) The locking device of Clause 14, wherein the sustaining element is square or circular from a bottom view.

(Clause 16) The locking device of Clause 14, wherein the sustaining structure further includes a driving component configured to drive the sustaining element to move upward or downward.

(Clause 17) The locking device of Clause 1, further including a first wear-resisting component and a second wear-resisting component embedded in the second element, wherein the first movable element and the second movable element are configured to slide on the first wear-resisting component and the second wear-resisting component, respectively.

(Clause 18) A pressure container, including: a housing defining a chamber; a lid configured to cover an opening of the housing; and a locking device configured to secure the lid in the opening of the housing, wherein the locking device includes: a plurality of locking elements being movable along a first direction, wherein the plurality of locking elements are non-rotatable; and a sustaining element being movable along a second direction substantially perpendicular to the first direction, wherein the sustaining element is configured to be disposed between the plurality of locking elements to sustain the plurality of locking elements.

(Clause 19) The pressure container of Clause 18, wherein the housing includes a base portion and an upper portion detachably attached to the base portion.

(Clause 20) The pressure container of Clause 18, further including a quartz tube and a heater disposed in the chamber, wherein the heater is disposed around the quartz tube to heat the quartz tube.

(Clause 21) The pressure container of Clause 18, wherein the plurality of locking elements are configured to be inserted into a plurality of recesses of the housing respectively and support the lid.

(Clause 22) The pressure container of Clause 18, wherein the sustaining element is configured to sustain the plurality of locking elements by face-to-face contact.

(Clause 23) The pressure container of Clause 18, wherein a resistance force between one of the plurality of locking elements and the sustaining element is along the first direction.

(Clause 24) A locking method, including: providing a second element surround by a first element defining a plurality of recesses; moving a plurality of movable elements into the plurality of recesses respectively, wherein a second portion of one of the plurality of movable elements is located outside one of the plurality of recesses; and moving a sustaining element to a position between the plurality of movable elements, wherein the sustaining element is configured to sustain the plurality of movable elements.

(Clause 25) The locking method of Clause 24, wherein the second portion of one of the plurality of movable elements supports the second element.

(Clause 26) The locking method of Clause 24, wherein a thickness of a first portion of one of the plurality of movable elements that is located in one of the plurality of recesses is less than a thickness of the second portion of one of the plurality of movable elements.

(Clause 27) The locking method of Clause 24, wherein one of the plurality of movable elements has two surfaces defining a recess corner, wherein the two surfaces of the one of the plurality of movable elements contact two surfaces of a corner of the one of the plurality of recesses, respectively.

(Clause 28) The locking method of Clause 24, wherein moving the plurality of movable elements includes moving the plurality of movable elements along a first direction, wherein moving the sustaining element includes moving the sustaining element along a second direction substantially perpendicular to the first direction.

(Clause 29) The locking method of Clause 28, wherein the plurality of movable elements are moved along the first direction straightly without rotation.

While certain embodiments have been described, these embodiments have been presented by way of example only, and are not intended to limit the scope of the disclosures. Indeed, the embodiments described herein may be embodied in a variety of other forms. Furthermore, various omissions, substitutions and changes in the form of the embodiments described herein may be made without departing from the spirit of the disclosures. The accompanying claims and their equivalents are intended to cover such forms or modifications as would fall within the scope and spirit of the disclosures.

What is claimed is:

1. A locking device, comprising:
a first element defining a first recess and a second recess opposite to the first recess;
a second element accommodated in the first element;
a first movable element configured to be inserted into the first recess and contact the second element;
a second movable element configured to be inserted into the second recess and contact the second element; and
a sustaining structure disposed between the first movable element and the second movable element, and configured to prevent the first movable element and the second movable element from moving away from the first recess and the second recess, respectively.

2. The locking device of claim 1, wherein the first element includes a ring structure including a sidewall, wherein a first portion of the sidewall defines the first recess, and a second portion of the sidewall defines the second recess, wherein the first recess and the second recess are curved from a bottom view.

3. The locking device of claim 2, wherein the first movable element and the second movable element are curved from the bottom view.

4. The locking device of claim 3, wherein a curvature of the first movable element is same as or different from a curvature of the first recess, wherein a curvature of the second movable element is same as or different from a curvature of the second recess.

5. The locking device of claim 1, wherein the first recess is communicated with the second recess, and the first movable element is separated from the second movable element.

6. The locking device of claim 1, wherein a bottom surface of the second element is substantially aligned with a top inner surface of the first recess and a top inner surface of the second recess.

7. The locking device of claim 1, wherein the first movable element and the second movable element are configured to slide on a bottom surface of the second element.

8. The locking device of claim 1, wherein the first movable element defines an indentation at a corner thereof, wherein a width of the indentation is less than a width of the first recess.

9. The locking device of claim 1, wherein the first movable element has two surfaces defining a recess corner, wherein the two surfaces of the first movable element are configured to contact two surfaces of a corner of the first recess, respectively.

10. The locking device of claim 1, wherein a first portion of the first movable element has a first thickness, a second portion of the first movable element has a second thickness different from the first thickness.

11. The locking device of claim 1, further comprising:
a first driving component configured to drive the first movable element; and
a second driving component configured to drive the second movable element.

12. The locking device of claim 11, wherein the first driving component includes a first bar, a first end of the first bar connects to the first movable element, and a second end of the first bar is configured to contact the sustaining structure; wherein the second driving component includes a second bar, a first end of the second bar connects to the second movable element, and a second end of the second bar is configured to contact the sustaining structure.

13. The locking device of claim 12, wherein the first end of the first bar is fixed to the first movable element, and the first end of the second bar is fixed to the second movable element.

14. The locking device of claim 1, wherein the sustaining structure includes a sustaining element configured to sustain the first movable element and the second movable element.

15. The locking device of claim 14, wherein the sustaining element is square or circular from a bottom view.

16. The locking device of claim 14, wherein the sustaining structure further includes a driving component configured to drive the sustaining element to move upward or downward.

17. The locking device of claim 1, further comprising a first wear-resisting component and a second wear-resisting component embedded in the second element, wherein the first movable element and the second movable element are configured to slide on the first wear-resisting component and the second wear-resisting component, respectively.
